(19) United States
(12) Patent Application Publication
(10) Pub. No.: US 2025/0372766 A1
(43) Pub. Date: Dec. 4, 2025

(54) BATTERY PACK WITH DIRECT COOLING CHANNELS

(71) Applicant: GM Global Technology Operations LLC, Detroit, MI (US)

(72) Inventors: SeungHwan Keum, Northville, MI (US); Ronald O. Grover, JR., Northville, MI (US); Chinmaya Patil, South Lyon, MI (US); Jian Gao, Auburn Hills, MI (US)

(73) Assignee: GM Global Technology Operations LLC, Detroit, MI (US)

(21) Appl. No.: 18/677,209

(22) Filed: May 29, 2024

(51) Int. Cl. H01M 10/6568; B60L 50/64; H01M 10/613; H01M 10/625; H01M 50/209; H01M 50/213; H01M 50/507; H01M 50/588

(52) U.S. Cl. CPC H01M 10/6568; B60L 50/64; H01M 10/613; H01M 10/625; H01M 50/209; H01M 50/213; H01M 50/507; H01M 50/588; H01M 2220/20

(57) ABSTRACT

A battery pack, comprising one or more battery cells each including a first end and a second end opposite the first end and one or more busbars communicatively coupled to the one or more battery cells at the first end. The battery pack further comprising a main body, comprising an upper end, a lower end opposite and spaced from the upper end, a first sump at the upper end, a second sump, one or more cell openings extending from the first sump to the second sump and configured to receive the one or more battery cells, and one or more fluid channels arranged in each of the one or more cell openings, the one or more fluid channels extending from the upper end to the lower end so that the fluid can directly contact the one or more battery cells.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery packs for electric vehicles and, more particularly, to direct fluid cooling of battery cells.

In general, rechargeable energy storage systems (RESS) include one or more battery cells that generate heat when a load is being discharged and/or when the cells are being charged. RESS can include a thermal management system or a cooling system to help manage thermal energy generated by the one or more battery cells. Typically, RESS rely on indirect cooling systems to remove heat from the battery cells. For example, some systems and methods rely on a ribbon chamber that is interweaved between the battery cells. A fluid can be circulated within the ribbon chamber and adjacent to the one or more battery cells to remove heat from the battery cells. However, this arrangement commonly results in uneven cooling of the battery cells due to inefficiencies of the ribbon chamber. Additionally, the ribbon chamber does not address thermal management of busbars, which can be a major heat source. Shortcomings of existing systems and method are addressed by one or more aspects of the present disclosure.

### SUMMARY

In one configuration, a battery pack is provided and includes one or more battery cells each including a first end and a second end opposite the first end and one or more busbars communicatively coupled to the one or more battery cells at the first end. The battery pack further includes a main body including an upper end, a lower end opposite and spaced from the upper end, a first sump at the upper end filled with a fluid that encapsulates the first end of the one or more battery cells and the one or more busbars, a second sump at the lower end filled with the fluid, one or more cell openings extending between the first sump and the second sump and configured to receive the one or more battery cells, and one or more fluid channels arranged in each of the one or more cell openings. The one or more fluid channels extending between the first sump and the second sump and configured to carry the fluid so that the fluid directly contacts the one or more battery cells.

The battery pack may include one or more of the following optional aspects or steps. For example, the battery cells are cylindrical battery cells.

According to at least one aspect, the battery cells are prismatic battery cells.

According to another aspect, the first sump and the second sump are in fluid communication with the one or more fluid channels. The main body can further include a first fluid conduit in fluid communication with the first sump and a second fluid conduit in fluid communication with the second sump.

According to at least one example, the first fluid conduit is an outlet and the second fluid conduit is an inlet.

According to another example, the first fluid conduit is an inlet and the second fluid conduit is an outlet.

According to at least one aspect, the fluid channels are vertical channels extending between the first sump and the second sump.

According to another aspect, the fluid channels are helical channels extending between the first sump and the second sump.

According to at least one example, the fluid channels are arranged in each cell opening to span a perimeter of the one or more battery cells.

According to another example, the main body is made from a fluid-tight potting material and encapsulates the one or more battery cells, the one or more busbars, the first sump, and the second sump.

In another configuration, an electric vehicle is provided and includes a vehicle body extending in a cross-car direction and a fore-aft direction and an electric motor coupled to the vehicle body. The electric vehicle further includes a battery pack coupled to the vehicle body and connected to the electric motor. The battery pack includes one or more battery cells including a first end and a second end opposite the first end and one or more busbars communicatively coupled to the one or more battery cells at the first end of the one or more battery cells. The battery pack further includes a main body including a first sump filled with a fluid for cooling the first end of the one or more battery cells and the one or more busbars, a second sump filled with the fluid for cooling the second end of the one or more battery cells, one or more cell openings configured to receive the one or more battery cells extending between the first sump and the second sump, and one or more fluid channels arranged in the cell openings between the one or more battery cells and the main body and configured to receive the fluid for directly cooling the one or more battery cells.

The electric vehicle may include one or more of the following optional aspects or steps. For example, the battery cells are cylindrical battery cells.

According to at least one aspect, the battery cells are prismatic battery cells.

According to another aspect, the first sump and the second sump are in fluid communication with the one or more fluid channels. The main body can include a first fluid conduit in fluid communication with the first sump and a second fluid conduit in fluid communication with the second sump.

According to at least one example, the first fluid conduit is an outlet and the second fluid conduit is an inlet.

According to another example, the first fluid conduit is an inlet and the second fluid conduit is an outlet.

According to at least one aspect, the fluid channels are vertical channels extending between the first sump and the second sump.

According to another aspect, the fluid channels are helical channels extending between the first sump and the second sump.

### BRIEF DESCRIPTION OF THE DRAWINGS

The drawings described herein are for illustrative purposes only of selected configurations and are not intended to limit the scope of the present disclosure.

FIG. 1 is a front perspective view of an example of an electric vehicle with a battery pack in accordance with principles of the present disclosure;

FIG. 2 is a perspective view of the battery pack of FIG. 1 including a portion of a main body, one or more battery cells, and one or more busbars according to the principles of the present disclosure;

FIG. 3 is a perspective view of a portion of the main body of the battery pack of FIG. 2 with the one or more battery cells and the one or more busbars removed;

FIG. 4 is a cross-sectional view of the battery pack of FIG. 1 having a first configuration of fluid channels; and

FIG. 5 is a cross-sectional view of the battery pack of FIG. 1 having a second configuration of fluid channels.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

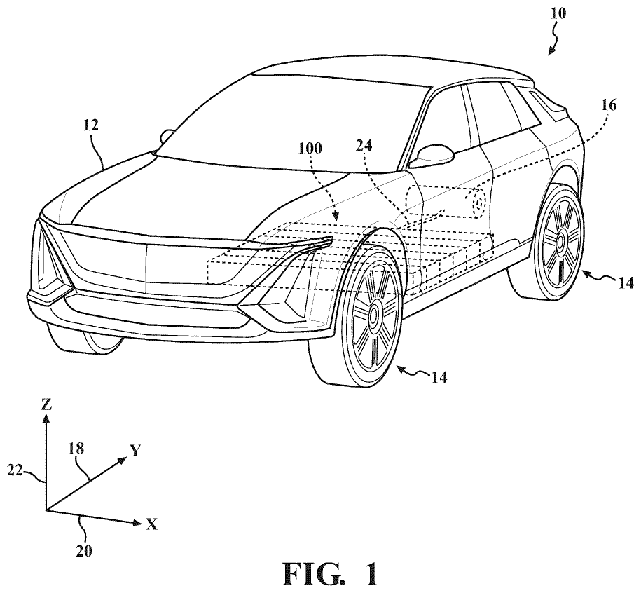

With reference to FIG. 1, a vehicle 10, such as an electric motor vehicle, is provided. The vehicle 10, includes a vehicle body 12, one or more wheels 14, and an electric motor 16 arranged in and/or coupled to the vehicle body 12. The vehicle body 12 extends along a first axis (i.e., a fore-aft or longitudinal direction) 18, a second axis (i.e., a cross-car or lateral direction) 20, and a third axis (i.e., a vertical direction) 22. The electric motor 16 can be configured to drive one or more of the one or more wheels 14 to propel the vehicle 10. The vehicle 10 includes a battery pack 100 that can be arranged in the vehicle body 12 and is communicatively coupled to the electric motor 16 via an electric power cable 24.

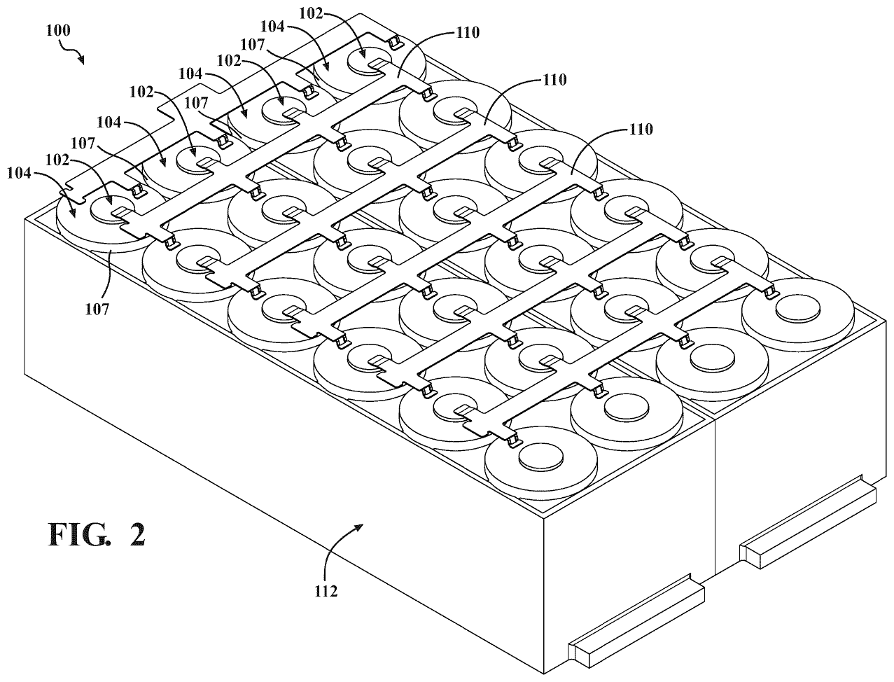

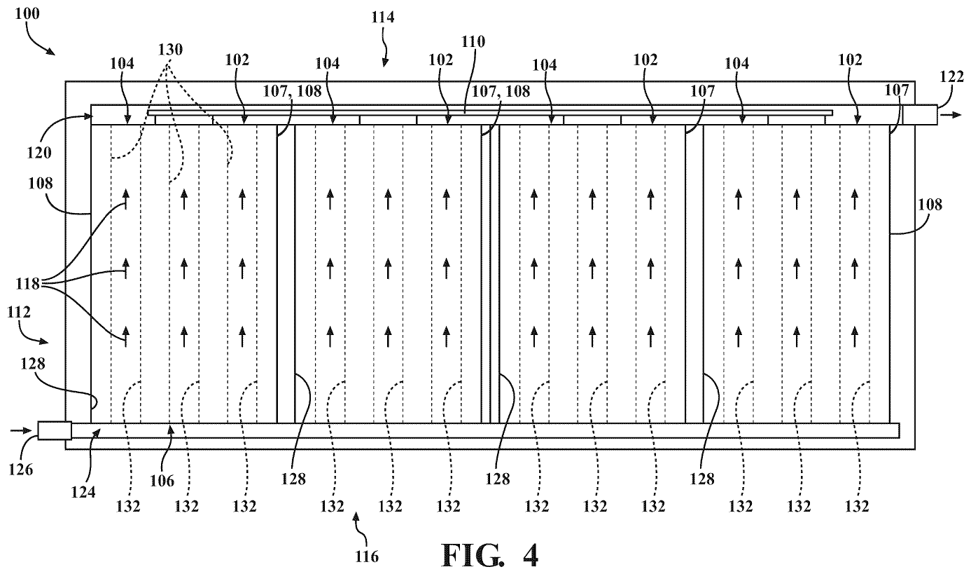

With reference to FIG. 2, an example of the battery pack 100 is provided and includes one or more battery cells 102. Each of the battery cells 102 includes a first end 104 and a second end 106 (FIG. 4) spaced from and opposite the first end 104 with respect to the third axis 22. One or more surfaces 107 extend between the first end 104 and the second end 106 and define a perimeter 108 that can be cylindrical, prismatic, or another shape used for vehicle battery cells. One or more busbars 110 are arranged on and/or coupled to the first ends 104 of the one or more battery cells 102.

The battery pack 100 further includes a main body 112 that extends between an upper end 114 and a lower end 116 opposite the upper end 114, as shown in FIG. 4. As will be discussed in more detail below, the main body 112 can be made of a fluid-tight potting material that encapsulates the one or more battery cells 102 and the one or more busbars 110 and allows a fluid 118 (e.g., a coolant) to flow from the lower end 116 to the upper end 114 or from the upper end 114 to the lower end 116. The fluid 118 can be a dielectric coolant, such as 3M® Novec, 3M® Fluorinert, purified water, silicone oil, castor oil, mineral oil, or another fluid commonly used to cool electrical components of a vehicle.

With continued reference to FIG. 4, the main body 112 can include a first or upper sump 120 arranged near the upper end 114 of the main body 112. The main body 112 can include a first fluid conduit 122 that is in fluid communication with the first sump 120 and can act as an inlet to supply the fluid 118 to the main body 112 or an outlet to remove the fluid 118 from the main body 112. The main body 112 can also include a second or lower sump 124 arranged near the lower end 116 of the main body 112. The main body 112 can include a second fluid conduit 126 that is in fluid communication with the second sump 124 and can act as an inlet to supply the fluid to the main body 112 or an outlet to remove the fluid 118 from the main body 112. Note, when the first sump and second sump are filled with the fluid 118, the first end of the battery cells 102, the busbars 110, and the second end of the battery cells are encapsulated by the fluid 118. In other words, the first sump 120 can be configured so that the fluid 118 can encapsulate the first end 104 of the battery cells 102 and the busbars 110, and the second sump 124 can be configured so that the fluid 118 can encapsulate the second end 106 of the battery cells 102.

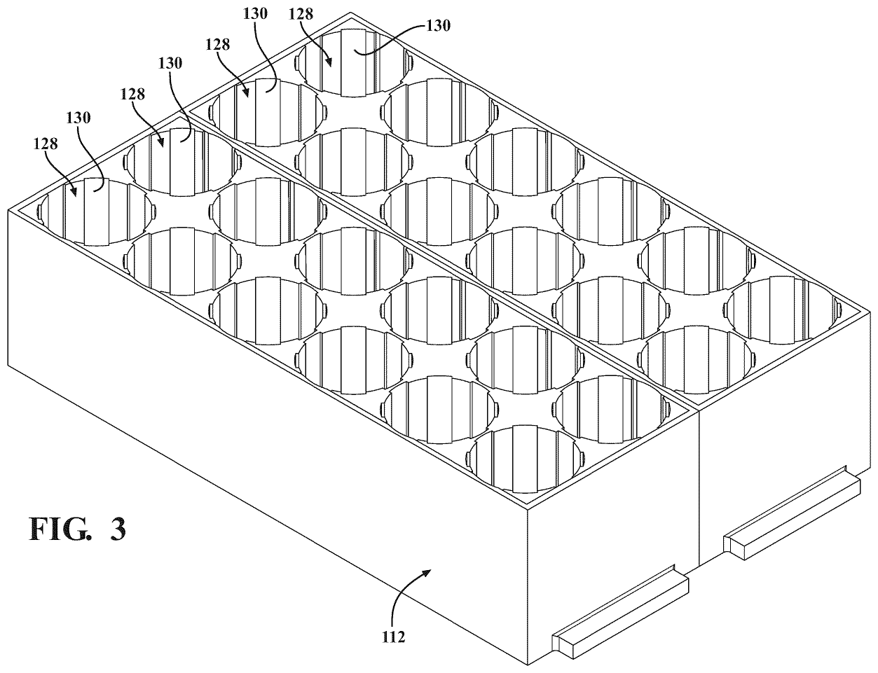

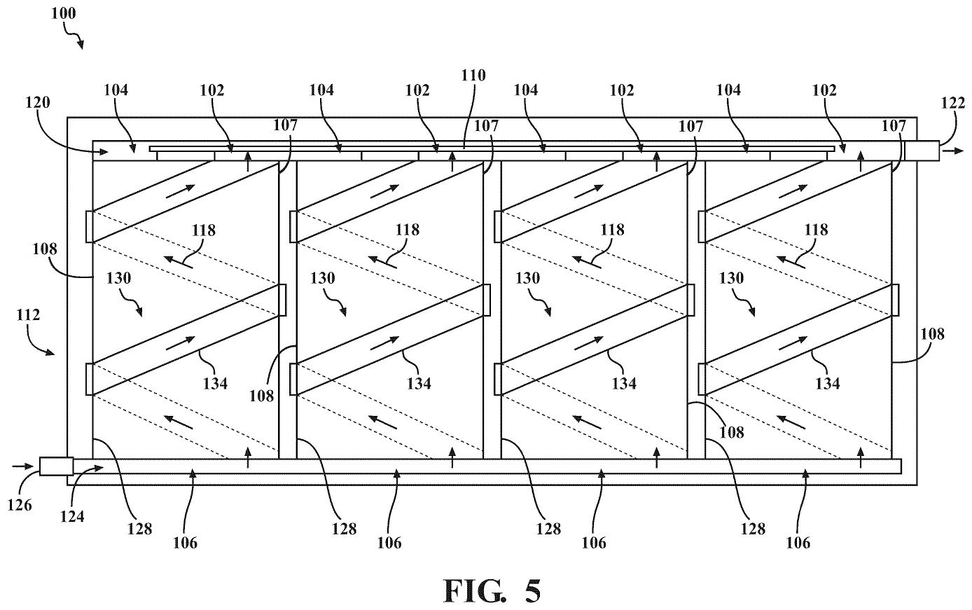

With reference to FIGS. 2 and 3, the main body 112 can define one or more cell openings 128 that are configured to receive and retain the one or more battery cells 102. The cell openings 128 can extend between the first sump 120 and the second sump 124, as shown in FIGS. 4 and 5. One or more fluid channels 130 can be arranged in each of the cell openings 128 so that the fluid 118 can directly contact the one or more surfaces 107 of the battery cells 102 and thermally manage (e.g., remove heat from) each of the battery cells 102. Direct contact between the fluid 118 and the battery cells 102 can be desirable because it can help eliminate inefficiencies that typically result when using one or more intermediary materials (e.g., ribbon material, thermal insulation material, etc.) to cool the battery cells 102.

With reference to FIGS. 4 and 5, the one or more fluid channels 130 can be vertical channels that are configured to carry the fluid 118 along at least a portion of the surfaces 107 of each of the battery cells 102 from the first sump 120 to the second sump 124 or from the second sump 124 to the first sump 120. In one configuration, with reference to FIG. 4, the fluid channels 130 are straight channels 132 that are arranged about the perimeter 108 between the first and second ends 104, 106 of each of the battery cells 102. In another configuration, with reference to FIG. 5, the fluid channels 130 are one or more helical channels 134 that span the perimeter 108 between the first and second ends 104, 106 of each of the battery cells 102. The fluid channels 130 can be bored out of the main body 112 or otherwise included during manufacturing of the main body 112.

In operation, with reference to FIGS. 3 and 4, the fluid 118 can enter the second fluid conduit 126 and fill the second sump 124. As the second sump 124 is filled, the fluid 118 directly contacts the second end 106 of each of the battery cells 102 as well as a portion of the perimeter 108 of each of the battery cells 102 as the fluid 118 enters the fluid channels 130 and flows toward the first sump 120. The direct contact between the fluid 118 and the battery cells 102 can be desirable for consistent thermal management of each of the battery cells 102 within the battery pack 100. As the fluid 118 reaches the first ends 104 of the battery cells 102 and fills the first sump 120, the busbars 110 are also directly contacted and encapsulated with the fluid 118. Encapsulating the busbars 110 can be desirable to remove heat from the busbars 110 without requiring an additional and/or separate thermal management mechanism. The fluid 118 can continue to flow out of the first fluid conduit 122 and is circulated back to the second fluid conduit 126 to continue removing heat from the battery cells 102.

As indicated above, in another configuration, the fluid 118 can enter the first fluid conduit 122 and flow from the first sump 120 along the one or more fluid channels 130 to the second sump 124 and exit the second fluid conduit 126.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery pack, comprising:
one or more battery cells each including a first end and a second end opposite the first end;
one or more busbars communicatively coupled to the one or more battery cells at the first end; and
a main body, comprising:
an upper end,
a lower end opposite and spaced from the upper end,
a first sump at the upper end filled with a fluid that encapsulates the first end of the one or more battery cells and the one or more busbars,
a second sump at the lower end filled with the fluid,
one or more cell openings extending between the first sump and the second sump and configured to receive the one or more battery cells, and
one or more fluid channels arranged in each of the one or more cell openings, the one or more fluid channels extending between the first sump and the second sump and configured to carry the fluid so that the fluid directly contacts the one or more battery cells.

2. The battery pack of claim 1, wherein the battery cells are cylindrical battery cells.

3. The battery pack of claim 1, wherein the battery cells are prismatic battery cells.

4. The battery pack of claim 1, wherein the first sump and the second sump are in fluid communication with the one or more fluid channels.

5. The battery pack of claim 4, wherein the main body further comprises a first fluid conduit in fluid communication with the first sump and a second fluid conduit in fluid communication with the second sump.

6. The battery pack of claim 5, wherein the first fluid conduit is an outlet and the second fluid conduit is an inlet.

7. The battery pack of claim 5, wherein the first fluid conduit is an inlet and the second fluid conduit is an outlet.

8. The battery pack of claim 1, wherein the fluid channels are vertical channels extending between the first sump and the second sump.

9. The battery pack of claim 8, wherein the fluid channels are helical channels extending between the first sump and the second sump.

10. The battery pack of claim 8, wherein the fluid channels are arranged in each cell opening to span a perimeter of the one or more battery cells.

11. The battery pack of claim 1, wherein the main body is made from a fluid-tight potting material and encapsulates the one or more battery cells, the one or more busbars, the first sump, and the second sump.

12. An electric vehicle, comprising:
a vehicle body extending in a cross-car direction and a fore-aft direction;
an electric motor coupled to the vehicle body; and
a battery pack coupled to the vehicle body and connected to the electric motor, the battery pack comprising:
one or more battery cells including a first end and a second end opposite the first end,
one or more busbars communicatively coupled to the one or more battery cells at the first end of the one or more battery cells, and
a main body, comprising:
a first sump filled with a fluid for cooling the first end of the one or more battery cells and the one or more busbars,
a second sump filled with the fluid for cooling the second end of the one or more battery cells,
one or more cell openings configured to receive the one or more battery cells extending between the first sump and the second sump, and
one or more fluid channels arranged in the cell openings between the one or more battery cells and the main body and configured to receive the fluid for directly cooling the one or more battery cells.

13. The electric vehicle of claim 12, wherein the battery cells are cylindrical battery cells.

14. The electric vehicle of claim 12, wherein the battery cells are prismatic battery cells.

15. The electric vehicle of claim 12, wherein the first sump and the second sump are in fluid communication with the one or more fluid channels.

16. The electric vehicle of claim 15, wherein the main body comprises a first fluid conduit in fluid communication with the first sump and a second fluid conduit in fluid communication with the second sump.

17. The electric vehicle of claim 16, wherein the first fluid conduit is an outlet and the second fluid conduit is an inlet.

18. The electric vehicle of claim 16, wherein the first fluid conduit is an inlet and the second fluid conduit is an outlet.

19. The electric vehicle of claim 12, wherein the fluid channels are vertical channels extending between the first sump and the second sump.

20. The electric vehicle of claim 19, wherein the fluid channels are helical channels extending between the first sump and the second sump.
